(19) United States
(12) Patent Application Publication
(10) Pub. No.: US 2009/0126507 A1
(43) Pub. Date: May 21, 2009

(54) Flow sensor

(75) Inventor: Roland Achhammer, Beratzhausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/921,778

(22) PCT Filed: Jun. 7, 2006
(86) PCT No.: PCT/EP2006/062962

§ 371 Date: Feb. 8, 2008

(30) Foreign Application Priority Data
Jun. 9, 2005 (DE) 10 2005 026 709.2

(51) Int. Cl. G01F 1/34

(52) U.S. Cl. 73/861.42

(57) ABSTRACT

A flow sensor for use in a main duct is disclosed. The flow sensor includes a main body having a bypass duct having an inlet and an outlet, a pressure loss element fixedly attached to the main body, and a sensor element disposed in the bypass duct. When the flow sensor is operatively mounted in the main duct, the inlet and the outlet are oriented perpendicularly with respect to a main flow direction of a fluid mass flow in the main duct, the pressure loss element is disposed in the main duct, downstream of the inlet and upstream of the outlet, and the sensor element is operable to generate a measurement signal which is a representative of the fluid mass flow.

The invention relates to a flow sensor, in particular an air mass flow rate sensor, which is suitable for use in a main duct, in particular in an intake section of an internal combustion engine.

Flow sensors are known which have a sensor element whose measurement signal is representative of a mass flow in a main duct, for example in an intake connector of an intake section of an internal combustion engine. Sensor elements of this type are formed by way of example, as temperature-dependent resistors. The heating power which is required from the sensor element is a measure of the mass flow which is to be sensed.

The object of the invention is to provide a simple flow sensor.

The object is achieved by means of the features of the independent patent claim. Advantageous refinements of the invention are characterized in the subclaims.

The invention is characterized by a flow sensor which is suitable for use in a main duct. The flow sensor has a body in which a bypass duct is formed. The bypass duct has in each case at least one inlet which is oriented, in the mounted state in the main duct, perpendicularly with respect to a main flow direction of a fluid in the main duct, and which has in each case at least one outlet which, in the mounted state in the main duct, is oriented perpendicularly with respect to the main flow direction of the fluid in the main duct.

It also has a pressure loss element which is fixedly coupled to the body, and in which, in the state of the flow sensor in which it is mounted in the main duct, is arranged downstream in the main direction of flow of the inlet and upstream in the main direction of flow of the outlet. In addition, the flow sensor comprises a sensor element which is arranged in the bypass duct and whose measurement signal is representative, in the state of the flow sensor in which it is mounted in the main duct, of a fluid mass flow which flows through the main duct. The pressure loss element is therefore free of attachment to the main duct, at least if it is not mounted in the main flow duct.

The flow sensor can be used as a plug-in component for a plurality of different cross sections of the main duct and can therefore be manufactured cost-effectively. Furthermore, the pressure loss element brings about, in the mounted state of the flow sensor, a suitable pressure drop between the inlet and the outlet of the bypass duct, and therefore permits, with interaction with the orientation of the inlet and the outlet, a throughflow to be measured on the basis of a measurement of a static pressure difference between the inlet and outlet, and furthermore allows a compact design of the flow sensor by virtue of the selected generation of the pressure loss by the pressure loss element.

The sensor element can be designed both to sense the pressure difference statically or to sense the pressure difference dynamically, in which case the sensor element is then embodied as a flow sensor element.

According to one of the advantageous refinements of the invention, the pressure loss element has a plurality of pressure loss ducts, each with a small cross section. This has the advantage that the pressure loss at low flow rates of the fluid in the main duct is high, while it is low at low flow rates. This contributes to a favorable measurement signal profile over a wide range of the flow rate.

According to a further advantageous refinement, the pressure loss element is a honeycomb body. In this way it is possible to ensure a particularly suitable pressure loss behavior.

According to one further advantageous refinement of the invention, the pressure loss element covers, in the mounted state, at least the area of the cross section of the main duct which is aligned with the outlet and the inlet. The pressure loss is therefore generated particularly effectively with respect to the inlet and the outlet.

According to a further advantageous refinement of the invention, the pressure loss element is connected to the body in a materially joined fashion. The flow sensor can therefore be manufactured particularly cost-effectively, in particular as a plastic injection molded part.

Exemplary embodiments of the invention are explained in more detail below with reference to the schematic drawings, in which:

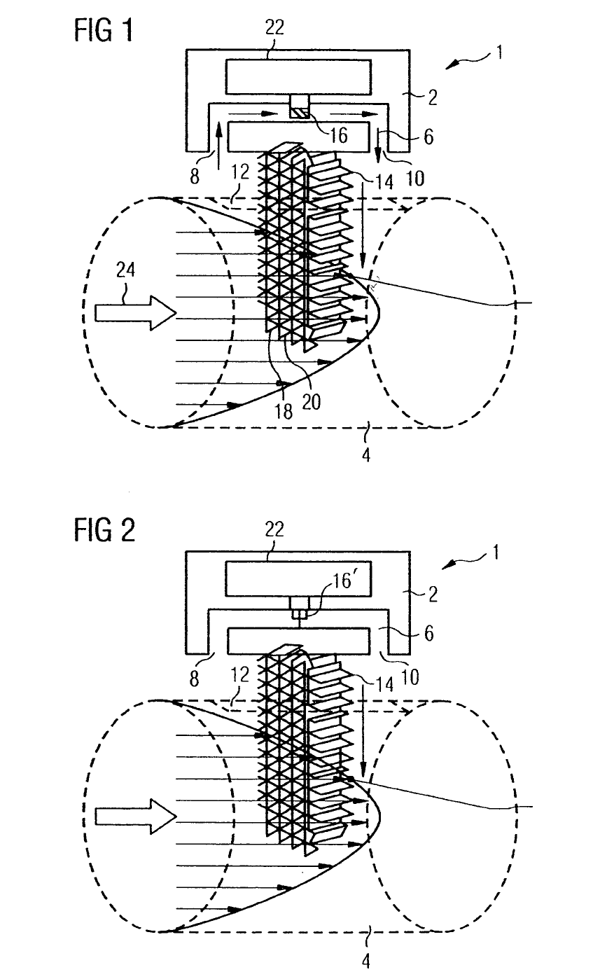

FIG. 1 shows a first embodiment of a flow sensor, and

FIG. 2 shows a second embodiment of the flow sensor.

Elements with the same design or function are characterized with the same reference symbols in all the figures.

A first embodiment of a flow sensor 1 (FIG. 1) has a main duct 4 which can be, for example, an intake connector of an intake section of an internal combustion engine. The flow sensor 1 is embodied in such a way that it can be inserted into a recess 12 in the main duct 4 and is inserted into the recess 12 correctly in a mounted state.

The flow sensor 1 has a body 2 in which a bypass duct 6 is formed. The bypass duct 6 has at least one inlet 8 and at least one outlet 10 which, in the mounted state, are each oriented perpendicularly with respect to a main flow direction of a fluid in the main duct 4. The main flow direction is represented by means of the arrow 24 in FIG. 1. The further arrows in FIG. 1 represent the distribution of the flow rate of the fluid flowing through the main duct 4. The bypass duct 6 can also be embodied in such a way that it has a plurality of inlets 8 and/or outlets 10, for example two, three, four or more inlets 8 or outlets 10. The important factor for the orientation of the inlets 8 and of the outlets 10 of the bypass duct in the mounted state of the flow sensor is that the static pressure difference between the inlet 8 and the outlet 10 in the bypass duct can be sensed. The flow sensor is introduced, in the mounted state, into the recess 12 of the main duct 4 and closes it off in a seal-forming fashion, in which case a sealing element is, if appropriate, also provided for this purpose.

A pressure loss element 14 is fixedly coupled to the body 2 and in the state of the flow sensor 1 in which it is mounted in the main duct, is arranged downstream of the inlet 8 and upstream of the outlet 10. The pressure loss element is fixedly coupled to the body 2, for example by means of a bonded connection, a welded connection or is, for example, formed in one piece with the body 2. The pressure loss element is preferably connected to the body in a materially joined fashion.

It is particularly advantageous if the pressure loss element is a plastic injection molded part which is preferably manufactured together with the body 2. The pressure loss element 14 is embodied in such a way that, in order to mount the flow sensor, said pressure loss element 14 can be inserted into the main duct 4 through the recess 12. The pressure loss element is preferably also embodied in such a way that, in the mounted state, it at least covers the area of the cross section of the main duct 4 which is aligned with the inlet 8 and the outlet 10. In this way it generates a different pressure difference between the inlet 8 and the outlet 10 as a function of the flow rate of the fluid in the main duct 4.

The pressure loss element 14 preferably has a plurality of pressure loss ducts, two of which are denoted by the reference numbers 18, 20 in FIGS. 1 and 2 by way of representation for the plurality of pressure loss ducts.

The pressure loss element 14 is preferably embodied as a honeycomb body, as illustrated in FIGS. 1 and 2. However, it can also be embodied in some other suitable way.

It is particularly advantageous if the pressure loss element 14 covers, in the mounted state of the flow sensor 1, as large a part as possible of the cross section of the main duct. In this context, a particularly favorable measurement behavior is obtained if the pressure loss element 14 extends into an area of high flow rates of the fluid in the main duct.

In addition, at least one sensor element 16 is arranged in the body 2, said sensor element 16 projecting into the bypass duct 6 and its measurement signal being, in the state of the flow sensor 1 in which it is mounted in the main duct 4, representative of a fluid mass flow which flows through the main duct 4. In the embodiment according to FIG. 1, the sensor element 16 is based on a dynamic pressure difference measurement and is embodied as a flow sensor. It can, for example, be embodied as a temperature-dependent resistor, for example as a hot film resistor.

In addition, the flow sensor 1 also comprises a signal processing electronic system 22 which is designed to condition the measurement signal of the sensor element.

A second embodiment of the flow sensor 1 (FIG. 2) differs from the first embodiment in that the sensor element 16 is based on a static pressure difference measurement. In this case, the sensor element 16 is embodied as a pressure difference sensor element and in this way senses the pressure difference between the inlet 8 and the outlet 10. In this case, the bypass duct is embodied in such a way that fluid cannot flow from the inlet to the outlet through the bypass duct 6. The sensor element can, in this case, comprise a diaphragm to which, on the one hand, the pressure in the part of the bypass duct 6 which communicates with the inlet 8 is applied, and to which on the other hand the pressure of the part of the bypass duct 6 which communicates with the outlet 10 is applied.

1.-5. (canceled)

6. A flow sensor for use in a main duct, comprising:
a main body having a bypass duct having an inlet and an outlet;
a pressure loss element fixedly attached to the main body; and
a sensor element disposed in the bypass duct,
wherein when the flow sensor is operatively mounted in the main duct, the inlet and the outlet are oriented perpendicularly with respect to a main flow direction of a fluid mass flow in the main duct, the pressure loss element is disposed in the main duct, downstream of the inlet and upstream of the outlet, and the sensor element is operable to generate a measurement signal which is a representative of the fluid mass flow.

7. The flow sensor of claim 6, wherein the pressure loss element comprises a plurality of pressure loss ducts.

8. The flow sensor of claim 6, wherein the pressure loss element comprises a honeycomb body.

9. The flow sensor of claim 6, comprising at least one section of the main duct for receiving the flow sensor, wherein the pressure loss element substantially covers the cross-sectional area of the at least one section of the main duct.

10. The flow sensor of claim 6, wherein the pressure loss element and the main body are materially connected to form a one-piece element.
